(19) United States
(12) Patent Application Publication
(10) Pub. No.: US 2014/0082879 A1
(43) Pub. Date: Mar. 27, 2014

(54) WIPER BLADE AND METHOD FOR PRODUCING A WIPER BLADE

(71) Applicants: Paul Criel, St. Truiden (BE); Hans Beelen, Herk de Stad (BE); Gert Vanderheyden, Tildonk (BE)

(72) Inventors: Paul Criel, St. Truiden (BE); Hans Beelen, Herk de Stad (BE); Gert Vanderheyden, Tildonk (BE)

(73) Assignee: ROBERT BOSCH GmbH, Stuttgart (DE)

(21) Appl. No.: 14/001,530

(22) PCT Filed: Feb. 16, 2012
(86) PCT No.: PCT/EP2012/052701

§ 371 Date: Dec. 4, 2013

(30) Foreign Application Priority Data
Feb. 24, 2011 (DE) 10 2011 004 646.1

(51) Int. Cl. B60S 1/38

(52) U.S. Cl. CPC B60S 1/3879
USPC 15/250.48; 264/261

(57) ABSTRACT

The invention relates to a wiper blade and to a method for producing a wiper blade, comprising a support element (12) for receiving a wiper strip (14), to which support element a connecting device (20) is attached, which has a wiper blade-side part (15) having claw-like receptacles (32, 34) surrounding the support element (12) at least in some regions. A gap (42) is provided between the support element (12) and at least one receptacle (32, 34). After the support element (12) is positioned in the receptacles (32, 34) of the connecting device (20), a compound (44) is introduced into the gap (42), said compound hardening in the gap (42).

### BACKGROUND OF THE INVENTION

In wiper blades for wiping panes, in particular vehicle panes, having a carrier element for receiving a wiper strip, to which there is secured a connection device which has a wiper-blade-side portion having claw-like receiving members, which at least partially engage round the carrier element, the carrier element is intended to ensure the most uniform possible distribution of the wiper blade contact pressure applied by the wiper arm to the pane over the entire wiping field which is covered by the wiper blade. As a result of a corresponding curvature of the unloaded carrier element—that is to say, when the wiper blade is not in abutment with the pane—the ends of the wiper strip which is placed fully on the pane during operation of the wiper blade are loaded by the carrier element which is then tensioned with respect to the pane even though the radii of curvature of spherically curved vehicle panes change with each wiper blade position. The curvature of the wiper blade must therefore be slightly greater than the greatest curvature measured in the wiper field on the pane to be wiped. A connection device by means of which the connection to the wiper arm is produced is secured to the carrier element.

From EP 0914269 B1 it is known to secure the connection device to the carrier element by means of a weld connection. To this end, the wiper-blade-side connection element which comprises either metal or a plastics material is applied or fitted to the carrier element and connected in a materially engaging manner to the carrier element by means of resistance welding in the case of a metal connection element or by means of ultrasound welding in the case of a plastics connection element. This welding connection is subjected to extreme conditions during everyday use and must withstand high levels of torques and vibrations even in differing weather conditions. In particular in the case of wiper blades which are produced in large batch numbers, a weld connection places high quality requirements on the execution of the process and thus makes the wiper blade more expensive, which is intended to be avoided precisely in the case of mass-produced products.

### SUMMARY OF THE INVENTION

The wiper blade according to the invention has the advantage that, owing to the additional mass, tolerances between the carrier element and the connection device are completely compensated for and a solid bond is produced. Neither the carrier element, nor the connection device has to be heated up to a liquid state in this instance so that the mechanical properties are not changed.

The expansion of the mass in the gap can thus effectively be limited when the gap is delimited at least in the direction of the wiper strip. The wiper strip is thus not influenced by the mass.

In order to nonetheless enable an extensive abutment of the carrier element against the receiving members of the connection device, there may be provision for the gap to extend only over two sides of the carrier element. This may, for example, be a convex upper side or the concave lower side of the carrier element and the narrow longitudinal side thereof.

A separate opening for introducing the mass is advantageously provided on the at least one receiving member and may be formed at an upper side or a lower side, depending on whether or not an additional covering cap is subsequently used. However, it is also conceivable for the opening to be provided at a narrow longitudinal side.

In order to be able to readily introduce the mass into the gap, it is advantageous for the mass to be flowable before the introduction operation and to solidify only when in the gap. To this end, the mass may be provided as a liquid or gel. However, it is also possible for the mass to be processed as a powder or granulate. Which administration form is to be selected is dependent on the one hand on the material of the mass itself and on the other hand on the process environment. For example, in a moist environment, a liquid or a gel would be used.

The mass is preferably a 2-component adhesive material and/or a resin since these materials can be processed for a defined period of time after the components have been blended, but can be stored for almost an unlimited period of time before the blending.

If the mass at least partially closes the opening provided for the introduction, during subsequent operation of the wiper blade dirt and water can thereby be prevented from accumulating there in increased quantities. Furthermore, the appearance is improved if the openings remain visible.

The bond between the carrier element and connection device can be improved if the carrier element has a recess through which the mass extends. If a portion of the mass also remains in the opening provided for the introduction, a connection is produced which positions the connection device in a positive-locking manner on the carrier element.

With the method according to the invention for producing a wiper blade, it is possible in a simple manner and without excessive supply of heat to secure the connection device to the carrier element. This is particularly effective when the mass which is introduced through an opening is distributed along the gap. This can be achieved in a particularly simple manner when the mass is pressed in by means of a piston or a stamp.

Flow behavior and solidification can be improved when the mass is heated before being introduced and is cooled after being introduced. Depending on the material of the mass, it is also possible to heat the mass only in the gap and then to solidify it, for example, by means of chemical reactions.

### BRIEF DESCRIPTION OF THE DRAWINGS

In the drawings:

FIG. 1 is a perspective view of a wiper blade according to the invention, with a wiper arm which is indicated with dot-dash lines, and a surface of a windscreen which is indicated with dot-dash lines;

FIG. 2 is a view according to II-II in FIG. 1;

FIG. 3 is a schematic illustration of the view according to FIG. 2 with only one resilient strip;

FIG. 4 is a schematic view in the viewing direction IV in FIG. 1 with only one end cap, and

FIGS. 5 and 9 are sectioned views of a receiving member in respect of various embodiments, respectively.

### DETAILED DESCRIPTION

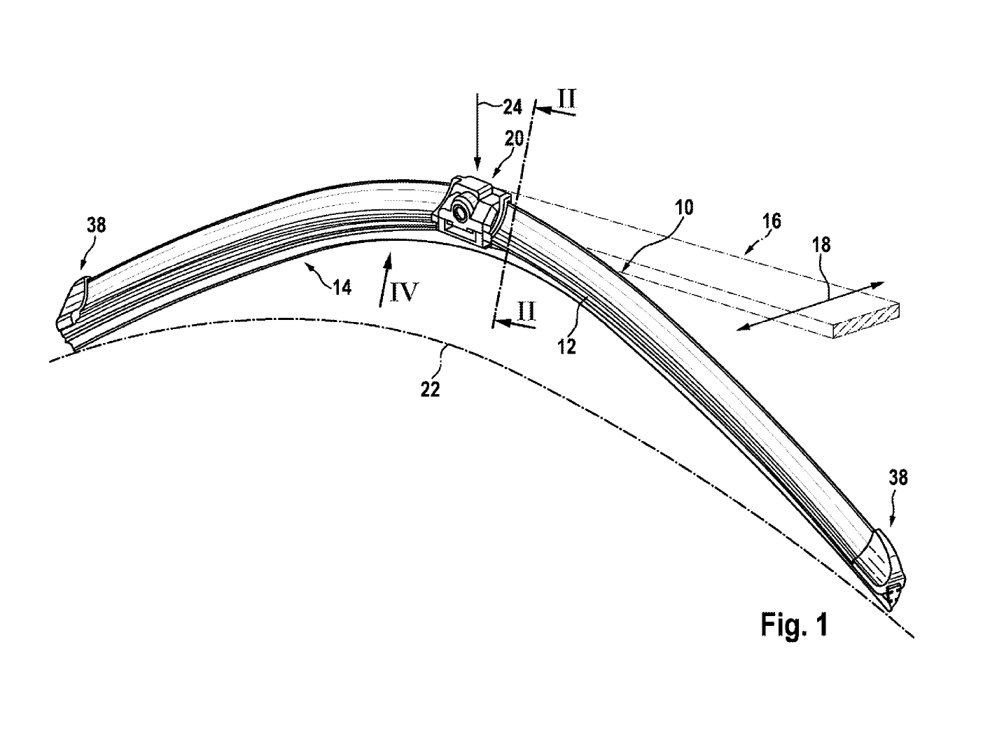

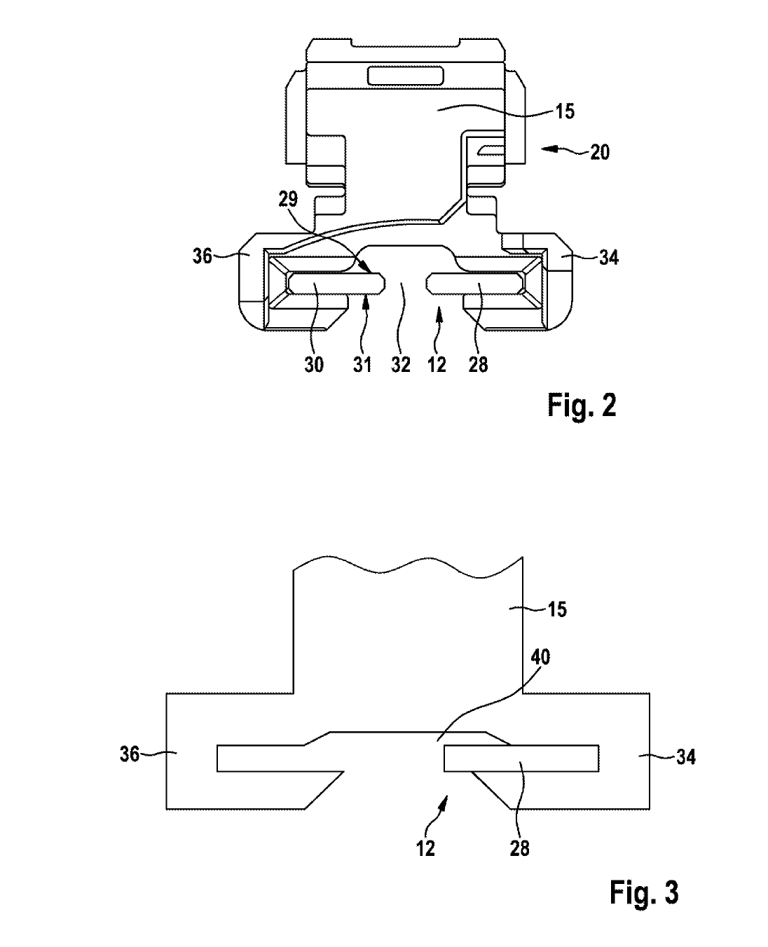

A wiper blade 10 shown in FIG. 1 has a resilient carrier element 12 (FIGS. 1 and 2) which is elongate in a strip-like manner and to whose lower strip side 13 facing the pane an elongate resilient wiper strip 14 is secured in a manner parallel with the longitudinal axis. At the upper strip side 11 of the carrier element 12 which can also be referred to as the resilient strip, facing away from the pane, there is arranged in the central portion thereof the wiper-blade-side portion 15 of a connection device by means of which the wiper blade 10 can be releasably connected in an articulated manner to a wiper arm 16 indicated with dot-dash lines in FIG. 1. The wiper arm 16 which is driven in an oscillating manner in the direction of a double-headed arrow 18 in FIG. 1 is loaded in the direction of an arrow 24 with respect to the pane to be wiped—for example, with respect to the windscreen of a motor vehicle—whose surface is indicated in FIG. 1 with a dot-dash line 22. Since the line 22 is intended to constitute the highest level of curvature of the pane surface, it can clearly be seen that the curvature of the wiper blade which abuts the pane with both ends thereof and which is not yet loaded is greater than the maximum pane curvature (FIG. 1). Under the contact pressure (arrow 24), the wiper blade 10 is in abutment with the pane surface 22 with the wiper lip 26 thereof over the entire length thereof. A tension is built up in the resilient carrier element 12 which is produced from metal and ensures correct abutment of the wiper strip 14 or the wiper lip 26 over the entire length thereof on the pane surface 22 and uniform distribution of the contact pressure (arrow 24).

The specific configuration of the wiper blade according to the invention will now be explained in greater detail below.

In FIG. 2, it can be seen that the carrier element 12 is constructed from two mutually separate resilient strips 28 and 30 which are spaced apart from each other and which form a gap 32. The connection device 15 has in a lower region two U-shaped receiving members 34 and 36, in which the resilient strips 28 and 30 are received. The receiving members 34 and 36 surround the resilient strips 28 and 30 over a relatively large portion of the cross-section thereof, the portion of the connection device 15 which corresponds to the wiper arm 16 being arranged at the convex side 29 of the carrier element 12 whilst the concave side 31 is opposite it.

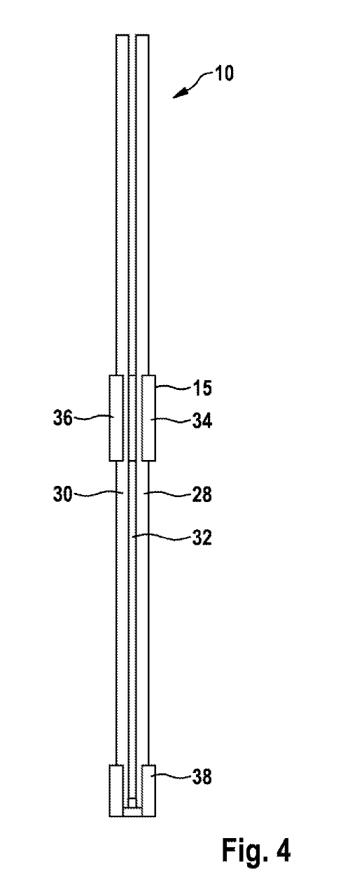

FIG. 3 is a schematic illustration of the connection device 15, the corresponding resilient strip 28 being drawn in the receiving member 34, whilst the resilient strip 30 is not in the corresponding receiving member 36. It can be seen that the receiving members 34 and 36 engage around the resilient strips 28 and 30 in a close-fitting manner. In the region above the resilient strips 28 and 30 and above the gap 32, the connection device 15 has a recess 40 in which, when the wiper blade 10 is assembled, an upper portion of a wiper strip comes to rest.

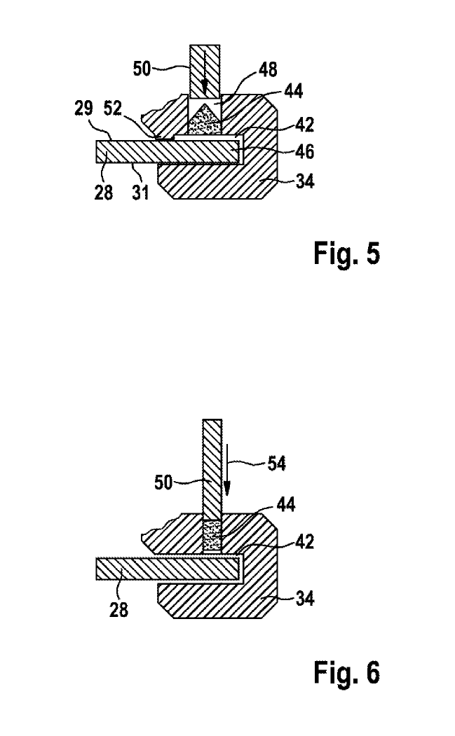

The wiper blade 10 which is illustrated from below in FIG. 4 and which is drawn without the wiper strip 14 or wiper lip 26 has the resilient strips 28 and 30, the gap 32 and the receiving members 34 and 36 of the connection device 15. It can be seen that, in this embodiment of the wiper blade 10, the resilient strips 28 and 30 are completely separate from each other and are held together only by the connection device 15 or by means of end caps 38, of which only one is drawn at one end in FIG. 4.

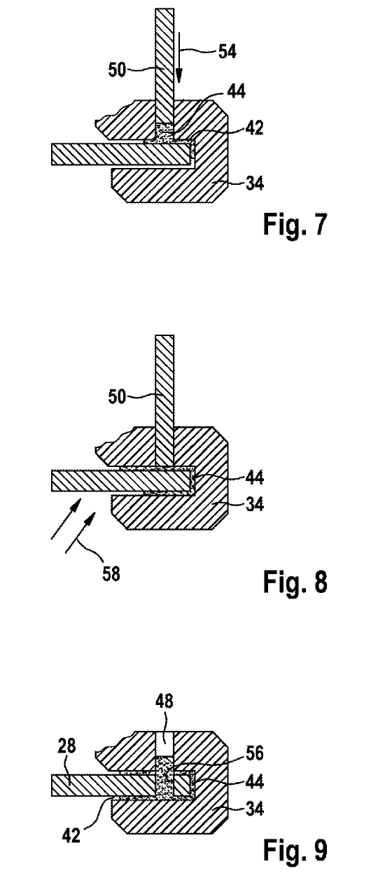

FIG. 5 is a sectioned view of the receiving member 34 in which a resilient strip 28 of the carrier element 12 is located. Between the receiving member 34 and the resilient strip 28 of the carrier element 12 there is a small gap 42 which extends in this embodiment at the convex upper side 29 and at the lateral longitudinal side 46. The concave lower side 31 rests directly in the receiving member 34. At a side facing the wiper strip 14 (not illustrated in FIG. 5), the gap 42 is delimited by a collar 52. Such a collar 52 may also be located in the region of the lower side if the gap 42 also extends at that location.

In an upper region of the receiving member 34, there is an opening 48 through which a mass 44 can be introduced. To this end, there is located in the opening 48 above the mass 44 a stamp 50 which can be moved downwards in the direction of the arrow indicated.

In FIGS. 6, 7 and 8, it is indicated how the mass 44 is distributed in the gap 42 by means of the stamp 50. To this end, as indicated in FIG. 5, the mass is first introduced into the opening, for example, sprinkled or blown in as powder or directly pushed in with the stamp 50 in compressed tablet form. It is also conceivable to introduce the mass with a liquid or gel-like consistency.

The stamp 50 is then moved in the direction of the arrow 54 so that, as can be seen in FIGS. 6 and 7, the mass 44 expands along the gap 42 and fills the gap 42. If, as illustrated in FIGS. 6 to 8, no collar 52 is provided, the quantity of the mass 44 must be provided in such a manner that an overflow is prevented. If the mass 44 is completely pressed in (FIG. 8), the stamp 50 is then pulled out when the solidification of the mass 44 has at least begun. Depending on the material of the mass 44, the solidification can be accelerated by heat 58 or ultraviolet light being supplied to the region of the gap.

Another embodiment is illustrated in FIG. 9, in which the introduction of the mass 44 is already complete and the stamp 50 has been removed. In this variant, the resilient strip 28 has a recess 56, through which the mass 44 has penetrated completely. Furthermore, a portion of the mass 44 remains in the opening 48. In this manner, after the solidification of the mass 44, a positive-locking bond is produced between the resilient strip 28 and the receiving member 34. In order to further reinforce the bond, the opening 48 can also be at least partially continued into a lower region of the receiving member 34. The recess 56 can also be produced at the edge of the resilient strip 28, 30. It is further possible to provide a plurality of recesses 56.

A wiper blade 10 according to the invention is produced as follows:

The resilient strips 28, 30 of the carrier element 12 are introduced into the receiving members 34, 36 of the connection device 20 so that a gap 44 is produced between the receiving members 34, 36 and the resilient strips 28, 30. The resilient strips 28, 30 are fixed relative to the connection device 20. The mass 44 is introduced into the openings 48 and pressed into the gap 44 by means of the stamp 50. After the mass 44 has solidified, the stamps 50 are removed and the wiper strip 14 is introduced. After the subsequent application of the end caps 38, a covering cap can also be placed over the connection device 20 if it is provided.

As the mass 44, it is possible to provide, for example, meltable polymers which are introduced in heated form into the openings 48 and cool and harden in the gaps 42. However, it is also possible to provide as the mass 44 thermosetting plastics which vulcanize and harden in the gaps 42. In order to accelerate the reaction, there may be provision for this region to be heated or to be irradiated with ultraviolet light.

It is also possible to provide the mass 44 as part of the wiper-blade-side portion 15, which is then melted in a first step by means of the sonotrodes and is pressed into the gap. A separate handling operation involving powder, gel or liquid is thereby dispensed with. The mass 44 would then be provided in a similar manner to FIG. 6 as a type of base in the opening 48.

1. A wiper blade for wiping panes, having a carrier element (12) for receiving a wiper strip (14), to which there is secured a connection device (20) which has a wiper-blade-side portion (15) having claw-like receiving members (32, 34), which at least partially engage round the carrier element (12), characterized in that there is provided between the carrier element (12) and at least one receiving member (32, 34) a gap (42) which is filled with a mass (44).

2. The wiper blade as claimed in claim 1, characterized in that the gap (42) is delimited at least in a direction towards the wiper strip (14).

3. The wiper blade as claimed in claim 1, characterized in that the gap (42) extends only over two sides of the carrier element (12).

4. The wiper blade as claimed in claim 1, characterized in that the at least one receiving member (32, 34) has at least one opening (48) for introducing the mass (44).

5. The wiper blade as claimed in claim 1, characterized in that the mass (44) is flowable before being introduced into the gap (42) and solidifies in the gap (42).

6. The wiper blade as claimed in claim 1, characterized in that the mass (44) is a liquid or a gel.

7. The wiper blade as claimed in claim 1, characterized in that the mass (44) is a powder or a granulate.

8. The wiper blade as claimed in claim 1, characterized in that the mass (44) is at least one of a 2-component adhesive material and a resin.

9. The wiper blade as claimed in claim 4, characterized in that the mass (44) at least partially closes the opening which is provided for the introduction.

10. The wiper blade as claimed in claim 1, characterized in that the carrier element has a recess (56) through which the mass (44) extends.

11. A method for producing a wiper blade, having a carrier element (12) for receiving a wiper strip (14), to which carrier element there is secured a connection device (20) which has a wiper-blade-side portion (15) having claw-like receiving members (32, 34), which at least partially engage round the carrier element (12) and a gap (42) is provided between the carrier element (12) and at least one receiving member (32, 34), characterized in that, after the carrier element (12) has been positioned in the receiving members (32, 34) of the connection device (20), there is introduced into the gap (42) a mass (44) which solidifies in the gap (42).

12. The method as claimed in claim 11, characterized in that the mass (44) is introduced through an opening (48) and is distributed along the gap (42).

13. The method as claimed in claim 11, characterized in that the mass (44) is pressed in by means of a piston or a stamp (50).

14. The method as claimed in claim 11, characterized in that the mass (44) is heated before being introduced and cools after being introduced.

15. The method as claimed in claim 11, characterized in that the mass (44) is heated in the gap (42) and thereby solidifies.
